(19) United States
(12) Patent Application Publication
(10) Pub. No.: US 2004/0147212 A1
(43) Pub. Date: Jul. 29, 2004

(54) Portable "Leg-Less" Fish Cleaning Station

(75) Inventors: Edward Adolph Leili, Panama City, FL (US); James Martin Overton, Panama City, FL (US)

Correspondence Address: James Martin Overton, 107 Legend Lakes Drive, P O Box 28384, Panama City, FL, 32411-8384

(73) Assignees: Edward Adolph Leili, Panama City, FL (US); James Martin Overton, Panama City, FL (US)

(21) Appl. No.: 10/707,928

(22) Filed: Jan. 26, 2004

Related U.S. Application Data
(60) Provisional application No. 60/319,905, filed on Jan. 27, 2003.

(51) Int. Cl. A22B 7/00

(52) U.S. Cl. 452/173

(57) ABSTRACT

A compact, light-weight, portable fish cleaning station which can be removably mounted on the outside surface of any marine piling, vertical post, tree or pole greater than 2 inches in diameter. The station is used to hold a fish for cleaning or cutting while allowing drainage of waste material into the water or bucket, when attached. The station includes a cutting board of wood and/or moldable structured plastic attached to two vertical support arms that are temporarily aligned over the face of a support piling and securely tied in position with the attached rope and cleat. The vertical support arms are designed with four primary contact points that insure a secure fit and prevent “wobble”. The width of the support arms is sufficient so that the station may be used on pilings or posts of various diameters. The station can be positioned at various heights for the comfort of the user. The station is easily removed from the piling, tree, post or vertical support and fold for easy storage.

### BACKGROUND OF INVENTION

1. Field of the Invention

This invention relates to devices used to clean fish and, more particularly, to portable devices that can be carried on the boat and used to clean fish at the marinas, loading ramps or other convenient locations where a fish cleaning device can be quickly and easily mounted to readily accessible fixtures such as pilings, trees, posts and other vertical supports.

2. Description of the Related Art

Fishermen usually find it desirable to clean and cool their catch soon after fishing is completed in order to keep the fish fresh and sanitary. In some circumstances, fish cleaning facilities are provided at the marinas where the fishermen maintain their boats or unload and load their boat off and onto a trailer. But often, there are no such facilities, or too few such facilities to meet the demand, and the fisherman is faced with either waiting until he or she returns home to clean the fish. This is not the preferred option for many reasons such as the time to drive home, and the mess associated with cleaning fish at home. Therefore, the fisherman is often faced with the challenge of providing his own means of cleaning his fish before returning me.

Fish cleaning devices that permanently or temporarily attach to trucks, trailers or to the side of the boat hull to hold the fish in a suspended position outside of the boat have been known for several years. For example, U.S. Pat. No. 3,561,043 (Breckenridge) discloses a boat-mounted holder for cleaning fish that includes a rigid trough held over the outside surface of the boat hull by a horizontal flange that extends over the outer edge of the gunwale. Two flexible cords are attached to the flange that extends over the gunwale to temporarily hold the trough over the outside surface of the hull. Hooks are attached to the end of the cords that engage the lower inside edge of the hull.

U.S. Pat. No. 3,668,739 (Lewis) discloses a rigid fish-cleaning trough mounted to the outside surface of the hull using two “C” clamps that extend over the gunwale, and attach to the inside surface of the hull.

U.S. Pat. No. 5,098,338 (Jensen) discloses a portable fish cleaner that includes a folding V-shaped trough that temporarily holds a fish in a suspended position over the outside surface of a boat. The trough is opened at its opposite ends which allows the fish waste to be washed into the water. The trough is supported by two support members that attach to clips permanently mounted on the outside surface of the boat to hold the trough in a suspended position over the outside surface of the hull.

U.S. Pat. No. 5,860,367 (Rieget, et al.) discloses a portable filleting table which is supported by foldable legs.

U.S. Pat. No. 5,522,765 (Dotson et al.) discloses a fish cleaning device which comprises a cleaning board with gripping means for gripping a fish while it is cleaned.

U.S. Pat. No. 5,542,359 (Polries) discloses a collapsible fish cleaning table which has a tabletop member with an upwardly facing work surface which is supported by collapsible legs attached to the bottom of the tabletop member.

U.S. Pat. No. 5,649,734 (Spies) discloses a tailgate box, table and sink which is mounted on the tailgate of a pickup truck while in use.

The prior art devices are unsatisfactory because they either require other devices for support while in use (i.e., a container or a pickup tailgate) or, if they provide their own means of support (i.e., legs), they are bulky and difficult to transport and store. One drawback with some fish cleaners found in the prior art is that they use troughs made of metal that can scratch or damage the sides of the hull. Because the troughs are relatively large structures that hang over the sides of the hull, waves often impact them causing them to disengage or causing damage to the hull. Another drawback is that because the troughs are relatively deep and narrow, they may block or impede the ability to cut through the fish with a knife. A still further drawback is that the surfaces on the trough are smooth and become slippery when wet thereby enabling the fish to move inside the trough when cutting longitudinally. More importantly, what is needed is an alternative to cleaning fish in your boats.

Another drawback to the previous art is that many states, like Florida, have enacted recent changes in Fishing Regulations that prohibit fishermen from cleaning their fish until they arrive back at the marina to insure that the fish meet the required size, quantity and variation limitations that are in affect at the time. Now, what is needed is a portable fish cleaning station that can be stored in a compact configuration on the boat and easily mounted to a piling or other vertical support found at most marinas. What is also needed is a fish cleaning station that can be selectively suspended at different heights to accommodate individual preferences. What is needed is a fish cleaning station that does not use a trough to hold the fish yet allows fish waste to be easily and quickly discarded into the water or into an attached waste bucket.

### SUMMARY OF INVENTION

The above-stated needs are met by the portable “leg-less” fish cleaning station disclosed herein which comprises a horizontally aligned cutting board with horizontal support sides that is temporarily mounted to a marina piling. The frame includes two vertical support arms that are attached to the cutting board with stainless steel hinges that are strong enough to hold fish up to 100 pounds. The vertical support arms include an attached rope and cleat used to securely fasten the fish cleaning station to the face of the vertical column or piling. The hinged vertical arms allow the cutting board to be raised during cleaning in order to scrape off waste material into the water or into a bucket that can hang from the handle below the board. The fish cleaning station is sufficient in size to accommodate fish in excess of 4 feet. The rope and cleat provide a very secure method of attaching the station to a variety of vertical supports. The rope and cleat method is widely used by many fishermen and provides a rapid and easy removal process. The handle on the bottom of the support arms makes a convenient carrying handle when the fish cleaning station is in the folded position. Said handle also makes a convenient place to hang a waste collection bucket while the station is being used.

Much of the prior art for fish cleaning devices were not for use on a boat. Those fish cleaning devices that were designed for a boat required a bracket, flange or other device to be connected to the boat, in some cases this could create a tripping hazard. Most of the forgoing devices were singular in use, that is they were for fish cleaning only while some could be used as dual purpose by including a bait cutting device.

CONCLUSIONS AND SCOPE: It can be seen that this device is not limited to shape, length, height, width or types of materials used. There are many different shapes of cutting boards and table tops. By use of the vertical mounting arms of this device, this device can be mounted to a large variety of vertical supports. One main advantage to this device is that it can be used for multiple purposes. One purpose is as a fish cleaning table mounted on a piling. Another purpose for this device is that it provides a bait cutting/prep station, a place to prepare bait for fishing. Another purpose for our device is a utility table for hunters or campers to keep items off the ground.

Although the description above contains many specificities, these should not be construed as limiting the scope of the device but as merely providing illustrations of some of the presently preferred embodiments of this device. Various other embodiments and ramifications are possible within it's scope. For example, light weight plastics would make it ideal for hunters climbing into a tree. The cutting board preferred material is high density polyethylene plastic. It is commonly used for cutting boards and can be easily cleaned to prevent contamination of germs, etc. Wood or other products may also be used. Thus the scope of the device should be determined by the appended claims and their legal equivalents, rather than by the examples given.

### BRIEF DESCRIPTION OF DRAWINGS

FIG. 1 is a detailed perspective view of the fish cleaning station.

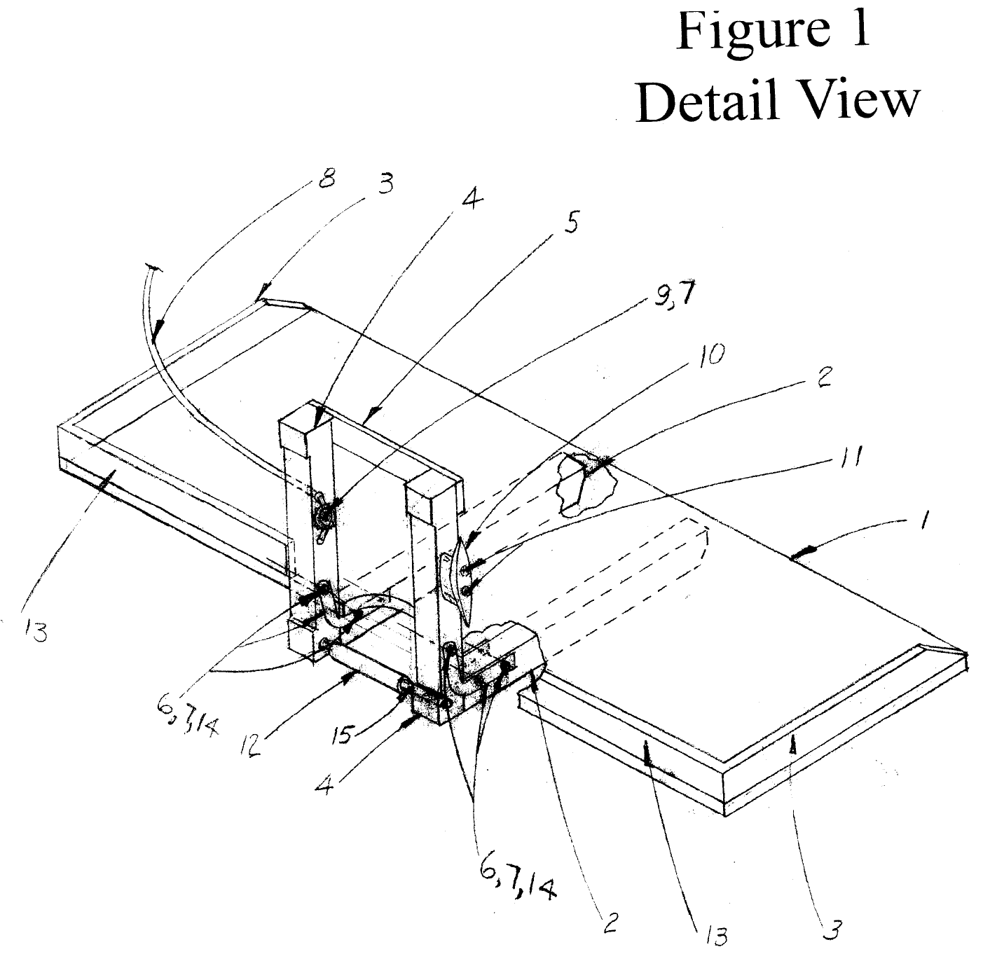

FIG. 2 is a top plan view of the fish cleaning station attached to a column.

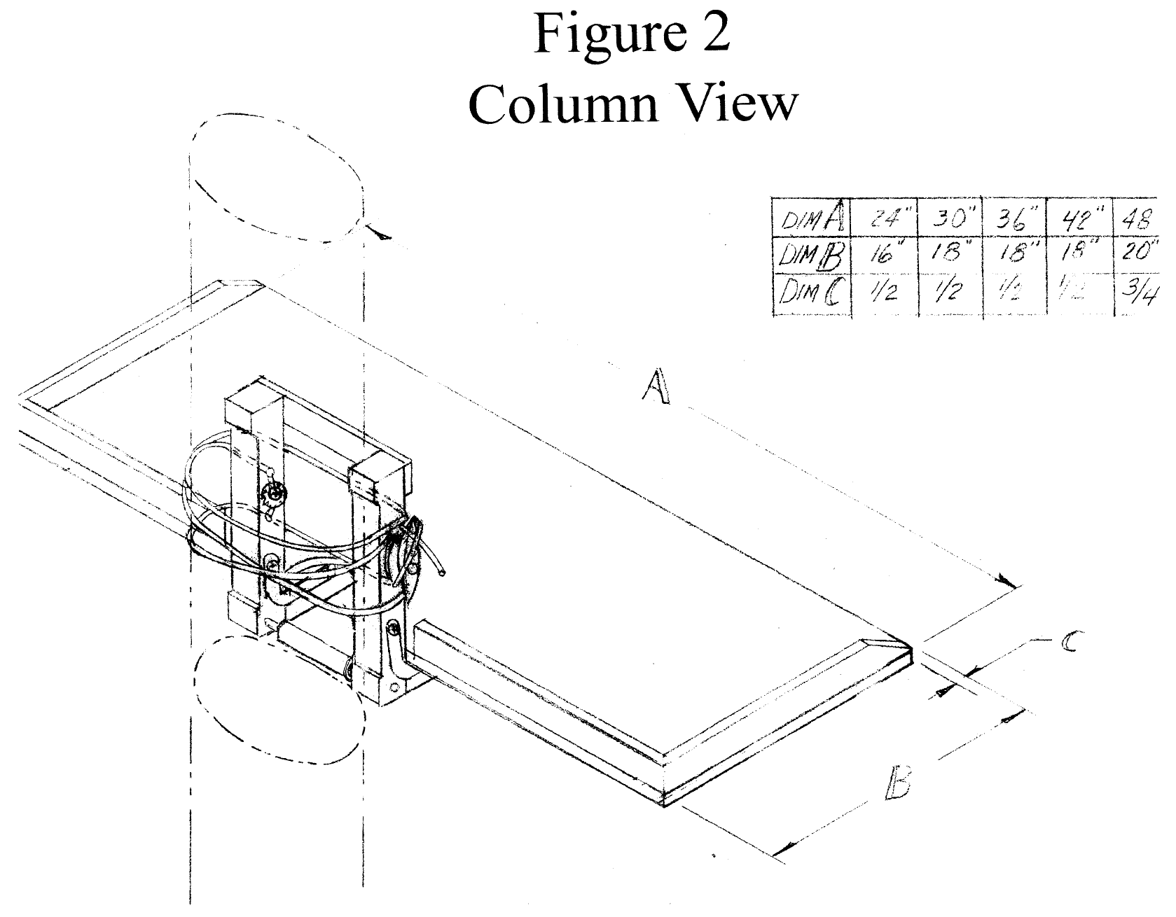

FIG. 3 is a folded view of the fish cleaning station.

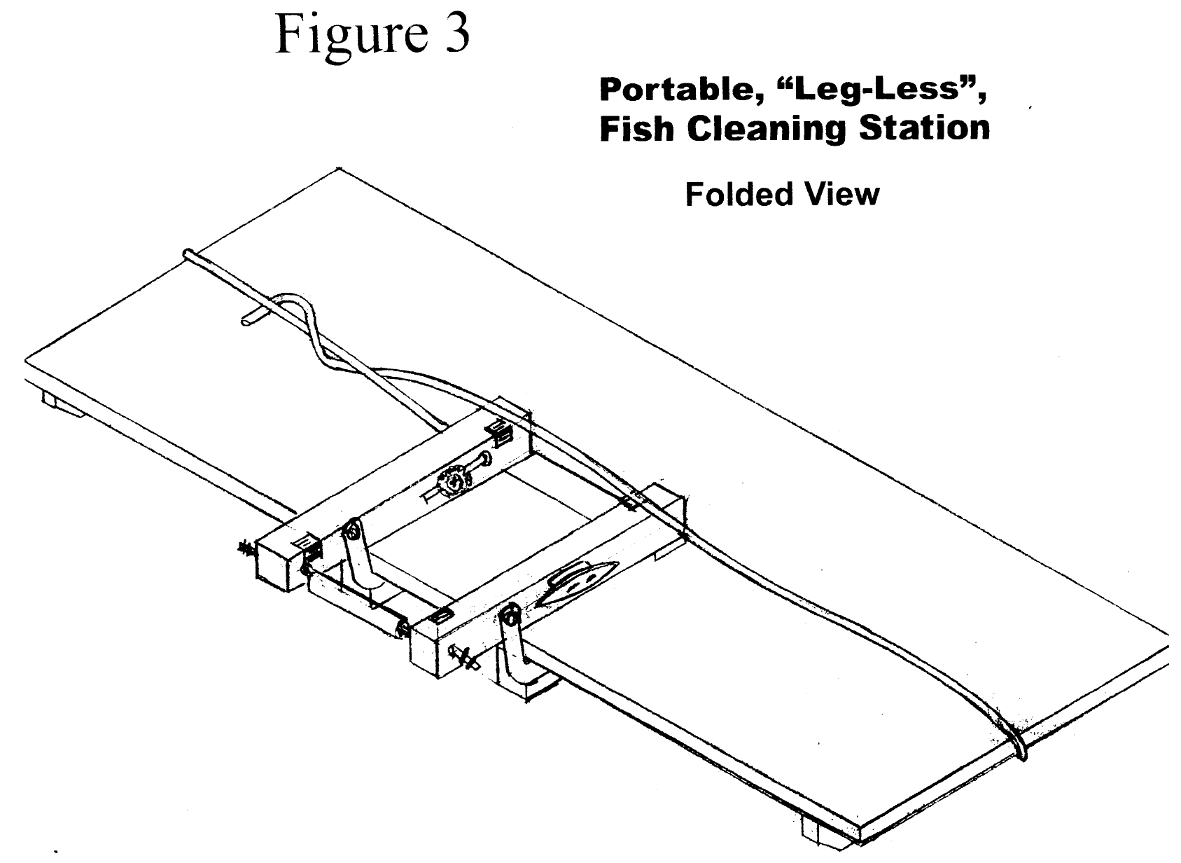

### DETAILED DESCRIPTION

1. Cutting Board—Made from a variety of woods: Cypress, Poplar, Oak and Moldable Plastics and is made in sizes from ½″ to ¾″ thick material. Sizes are in the following dimensions: 24″ Long by 16″ Wide, 30″ Long by 16″ Wide, 36″ Long by 18″ Wide, 42″ Long by 20″ Wide

2. Center Support Mount: 1½ by 1½ wood or molded plastic (2 required, nailed and cemented in place with waterproof cement).

3. Side Support Board: ½″ by 1½″ wood or molded plastic (2 required, nailed and cemented in place with waterproof cement).

4. Vertical Support Arm: 1½″ by 1½″ wood or molded plastic (2 required, nailed and cemented in place with waterproof cement).

5. Support Plate, Hinge Mount: ¼″ by 1½″ by 5⅞″ wood or molded plastic (1 required, nailed and cemented in place with waterproof cement).

6. Hinge, Support Mounting: 0.045 thick stainless steel (4 required).

7. Mounting Screws, Hinge: #10 Pan Head by ⅝″ long, stainless steel (12 required).

8. Rope, Pole Mounting: ⅜″ Nylon Rope, length=12′.

9. Star Washer—#10 Stainless Steel (1 required)

10. Mounting Cleat″ Molded plastic secured to Pole Mounting Hinge Support with item #11. (1 required)

11. Mounting Screw: #8 Flat Head by 1½″ long, stainless steel (2 required).

12. Handle: ⅝ O.D. P.V.C. Pipe 4½″ long (1 required).

13. Rear Support Board: ½″ by 1½″ by 14″ wood or molded plastic (1 required).

14. Crimp, retaining: ⅜″ stainless steel (2 required).

15. Handle Holder: Dowell ⅜″ thick by 7½″ wide wood or molded plastic (1 required).

I claim:

1. A portable “Leg-Less” apparatus for cleaning fish, wherein said apparatus is removably attached to any piling or other vertical column having a diameter greater than 2 inches, said apparatus comprising:
(a) a rectangular frame cutting board of wood or moldable plastics having two Vertical Support Arms arms and two Side Support Boards and twp Rear Support Boards for strength;
(b) a nylon rope attaching to the Pole Mounting Hinge Supports, said rope being sufficient in size to allow the station to be tied to vertical supports in excess of 18 inches in diameter;
(c) a plurality of stainless steel hinges that attach to the Pole Mounting Hinge Supports to allow the station to rotate up for cleaning off waste material and to fold flat for convenient storage;
(d ) mounting cleat aligned and attached to either side of the Pole Mounting Hinge Supports arms to allow the previous rope to be fastened securely;
(e) handle ⅝ inch in diameter that extends between the Pole Mounting Hinge Support arms at the bottom, to form a carrying handle, said handle is covered with P.V.C. ¾ inch;
(f) support plate connected to each Pole Mounting Hinge Support, said support plate which selectively holds said support arms in place for mounting.
(g) the use of stainless steel screws, nuts and bolts for assembly.
(h) a semi-circle cutout on the cutting board to allow for fish waste to be scraped into the water, or into a bucket which can be attached to the handle below the board.
